(19) United States
(12) Patent Application Publication
(10) Pub. No.: US 2026/0310270 A1
(43) Pub. Date: Oct. 8, 2026

(54) MANAGING LIQUID COOLING INFRASTRUCTURE AND REDUNDANCIES USING PLANNING TEMPLATE

(71) Applicant: American Megatrends International, LLC, Duluth, GA (US)

(72) Inventors: Chitrak Gupta, Johns Creek, GA (US); Varadachari Sudan Ayanam, Suwanee, GA (US)

(21) Appl. No.: 19/169,386

(22) Filed: Apr. 3, 2025

(51) Int. Cl. G06F 1/20; G05B 19/05

(52) U.S. Cl. CPC G06F 1/20; G05B 19/05; G05B 2219/14006

(57) ABSTRACT

In an aspect of the disclosure, a method, a computer-readable medium, and a system are provided. The system may include one or more computing devices. The one or more computing devices receive a planning template that defines a topology of a liquid cooling infrastructure. The planning template includes one or more component entries for one or more components of the liquid cooling infrastructure. The one or more computing devices configure monitoring parameters for the liquid cooling infrastructure based on the planning template. The one or more computing devices receive sensor data from the liquid cooling infrastructure. The liquid cooling infrastructure includes at least one of: a physical liquid cooling infrastructure or a simulated liquid cooling infrastructure. The one or more computing devices manage the liquid cooling infrastructure based on the sensor data and the planning template.

### BACKGROUND

### Field

The present disclosure relates generally to computer systems, and more particularly, to techniques of managing liquid cooling infrastructures in data centers using a structured planning template that defines cooling system topology, component relationships, and failure management procedures.

### Background

The statements in this section merely provide background information related to the present disclosure and may not constitute prior art.

Traditional data centers have historically relied on air-based cooling systems, using fans and air conditioning units to maintain appropriate operating temperatures for servers and computing equipment. As computational demands increased and high-performance processors and GPUs became more prevalent, these traditional air cooling methods began to show their limitations in effectively dissipating the increasing thermal loads. This led to the development and adoption of liquid cooling solutions, including direct-to-chip liquid cooling with cold plates and immersion cooling where servers are submerged in dielectric liquid.

In certain liquid-cooled data center implementations, the management of cooling infrastructure is typically vendor-specific and siloed. Different cooling distribution units (CDUs) and chillers often come with their own proprietary management interfaces and protocols, such as Modbus, SNMP, or vendor-specific REST APIs. This heterogeneous environment made it challenging for data center operators to implement comprehensive monitoring and management solutions across their cooling infrastructure. Additionally, redundancy configurations and failure handling were often handled in an ad-hoc manner, without standardized approaches for defining and managing different redundancy topologies.

Certain systems for managing liquid cooling systems may rely on basic monitoring of temperature and pressure sensors, with simple threshold-based alerts. These systems lacked comprehensive failure mode analysis and structured planning for different types of failures that could occur in complex liquid cooling infrastructures. While some vendors provided management solutions for their specific components, there was no standardized way to define and manage the entire cooling infrastructure topology, including the relationships between chillers, CDUs, and immersion tanks. Furthermore, the handling of different redundancy configurations is often implemented through custom scripts or manual procedures rather than through a structured management framework.

The increasing complexity of liquid cooling systems, combined with the critical nature of cooling in high-density computing environments, created a need for more sophisticated management approaches.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The system may include one or more computing devices. The one or more computing devices receive a planning template that defines a topology of a liquid cooling infrastructure. The planning template includes one or more component entries for one or more components of the liquid cooling infrastructure. The one or more computing devices configure monitoring parameters for the liquid cooling infrastructure based on the planning template. The one or more computing devices receive sensor data from the liquid cooling infrastructure. The liquid cooling infrastructure includes at least one of: a physical liquid cooling infrastructure or a simulated liquid cooling infrastructure. The one or more computing devices manage the liquid cooling infrastructure based on the sensor data and the planning template.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system having a baseboard management controller (BMC) and a host computer.

FIG. 2 is a diagram illustrating a liquid cooling infrastructure for a data center comprising a liquid immersion tank, a cooling distribution unit, and a chilled loop.

FIG. 3 is a diagram illustrating a management architecture for a liquid cooling system comprising parallel cooling subsystems connected to a common chilled loop.

FIG. 4(A) and FIG. 4(B) is a diagram illustrating different cooling topology configurations comprising a basic single CDU configuration and a redundant dual CDU configuration.

FIG. 5 is a flow chart illustrating a method for managing a liquid cooling infrastructure based on a planning template.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

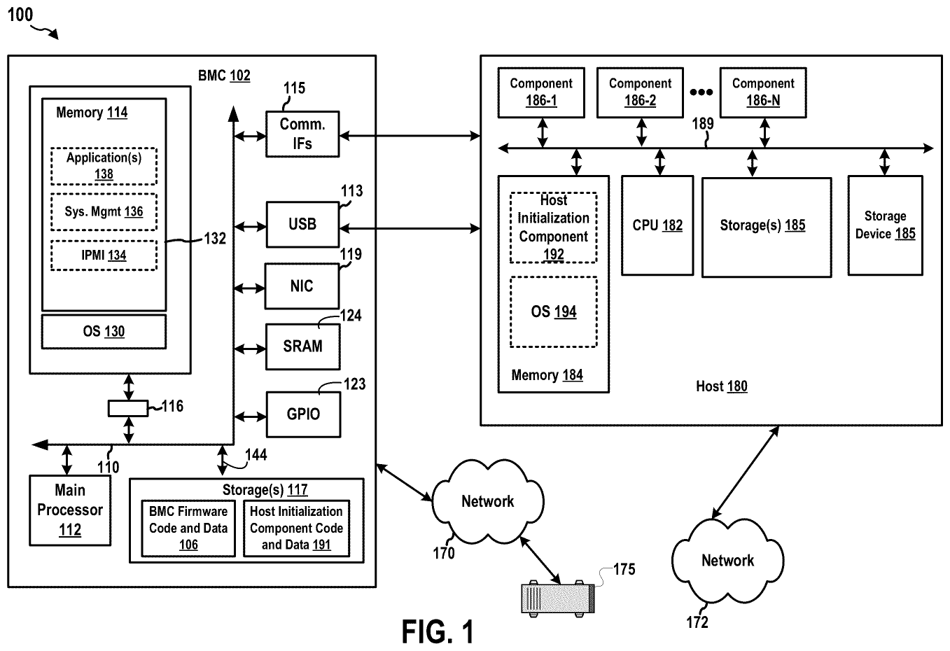

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network. The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

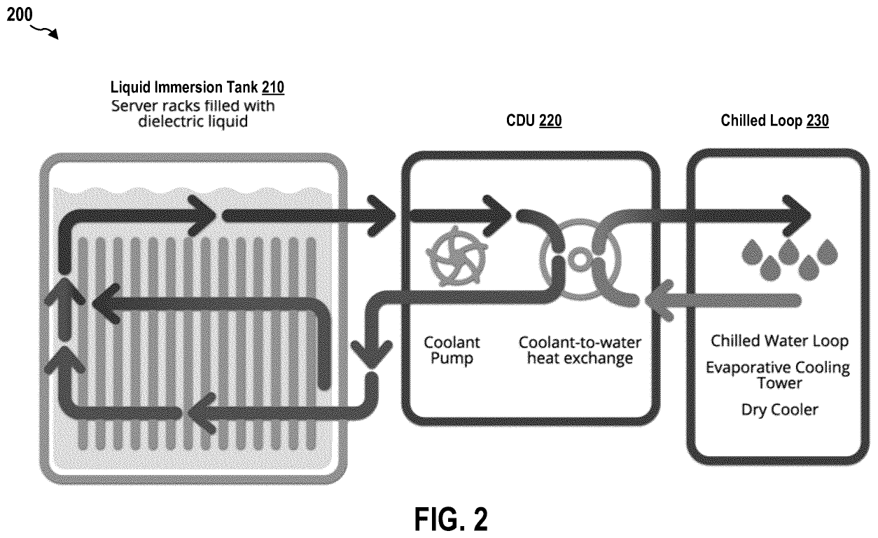

FIG. 2 is a diagram 200 illustrating a liquid cooling infrastructure for a data center. The infrastructure includes three main components: a liquid immersion tank 210 containing server racks immersed in dielectric liquid, a cooling distribution unit (CDU) 220, and a chilled loop 230. The liquid immersion tank 210 houses multiple server racks in a dielectric liquid environment. This circulation enables efficient heat transfer from the immersed servers to the cooling liquid.

The CDU 220 may contains a coolant pump and a coolant-to-water heat exchanger. The coolant pump circulates the dielectric liquid through the system, while the coolant-to-water heat exchanger facilitates thermal transfer between the dielectric liquid and the water-based cooling system. The CDU 220 serves as the primary interface between the immersion cooling system and the facility's chilling infrastructure.

The chilled loop 230 represents the facility-level cooling infrastructure. It may incorporate various cooling technologies including an evaporative cooling tower and a dry cooler. These components are responsible for dissipating the heat collected from the servers into the external environment. The chilled loop 230 completes the thermal management cycle by providing cooled water back to the CDU 220.

The infrastructure may form a closed-loop cooling system. This configuration addresses the increasing thermal management challenges in modern data centers, particularly those housing high-power components such as GPUs.

The infrastructure illustrated in FIG. 2 represents a shift from traditional air-cooling methods to more efficient liquid cooling solutions. This transition is necessitated by the growing power density in data centers and the corresponding increase in heat generation.

In modern data centers, growing computational demands and the widespread adoption of high-power processors, such as GPUs, have intensified the need for efficient cooling methods. Traditional air-based cooling approaches may be insufficient for these systems, particularly when heat dissipation requirements become substantial. As a result, liquid cooling infrastructures have emerged as a more capable solution, offering improved heat transfer and reduced thermal resistance compared to conventional fan-based systems. One implementation of this liquid-based approach employs a liquid immersion tank (the tank 210 in FIG. 2), a coolant distribution unit (the CDU 220), and a chilled loop (the chilled loop 230). This setup provides a closed-loop mechanism by which heat is removed from submerged servers, transferred through the dielectric liquid to the CDU 220, and ultimately carried to the chilled loop 230, which directs the thermal load to a tower or a dry cooler for final dissipation. These systems can be modeled in a simulation environment or digital twin that creates a replica of the real-world implementation to test various scenarios before physical deployment.

A single CDU 220 may serve one immersion tank 210 or multiple tanks, depending on the data center's capacity and design preferences. Likewise, one immersion tank 210 may be supported by multiple CDUs 220 in redundant topologies to mitigate pump or power supply failures. In certain architectures, each CDU 220 contains a pump array and a coolant-to-water heat exchanger, enabling fluid circulation between the tank 210 and the facility's water-based chilled loop 230. Sensors integrated into the CDU 220 measure operating parameters such as coolant temperature, coolant flow, and pressure. These sensors often communicate with a programmable logic controller and report status to an external manager over protocols including Modbus, SNMP, or Redfish-based interfaces.

A significant challenge in integrating these systems arises when the data center management service must interpret a wide variety of cooling configurations. The management service benefits from prior knowledge of the infrastructure, including the number of CDUs 220, the number of tanks 210, and the redundancy sets present in the design. To address this challenge, a data center planning document may be formulated in a structured format such as JSON. This document defines component relationships and redundancy configurations for each segment of the infrastructure, mirroring the way a platform sensor map file describes the layout of sensors and control points in a server. In liquid-cooled environments, the planning document specifies items such as the chiller capacity, the failure modes of the pumps in the CDU 220, and the correct response to sensor anomalies in the immersion tank 210 or the chilled loop 230. The management service references this document to identify the topology and interpret real-time sensor data in both real deployments and simulated environments, allowing administrators to test various scenarios before implementing changes in production environments.

The planning document also captures a failure modes and effects analysis (FMEA) across the cooling chain. For example, a single immersion tank 210 may be associated with multiple redundant CDUs 220, each featuring redundant pumps or power supplies. If one pump fails to start, the management service detects this scenario based on the prior mapping and the information from the sensors. The planning document indicates that pump redundancy can help maintain the cooling flow, although the reduced operational margin might trigger recommended actions such as predictive maintenance schedules or firmware updates. Further failure modes, such as coolant loop leaks or control system malfunctions, are likewise addressed by referencing the document's enumerations of causes, sensor-based detections, and subsequent mitigating responses. These details guide both automated and manual interventions, including steps for sealing leaks or recalibrating sensors.

The JSON-based planning template thus serves as an overarching recipe for how the system should be orchestrated. Administrators can populate entries detailing the thermal loads of each server rack in the immersion tank 210, the intended operational range of the coolant temperatures, and the expected failure responses of the CDU 220. When imported into the management application, this information becomes the blueprint for monitoring and controlling the cooling infrastructure in both real deployments and simulated environments. The management application, after reading the document, sets up the requisite sensor polling mechanisms, determines which parameters to track in real time, and identifies the actions to be taken when anomalies arise. If a pump in the CDU 220 exhibits declining efficiency or a sensor in the chilled loop 230 reports abnormal pressures, the management application consults the planning template to notify operators or to command a secondary pump to activate. These scenarios can be tested in a digital twin environment before implementation in the actual data center, allowing administrators to validate their response strategies without risking production systems.

This integrated arrangement of the immersion tank 210, the CDU 220, and the chilled loop 230 defines a scalable and configurable cooling architecture. Through a structured definition of the cooling system design and its operational logic, the planning document enables a manager service to parse complex redundancy relationships and to respond promptly to equipment failures and process interruptions. The result is a more flexible deployment model for liquid cooling in data centers, one that incorporates thorough planning, real-time monitoring, and proactive failure management without requiring specialized re-engineering for each new configuration.

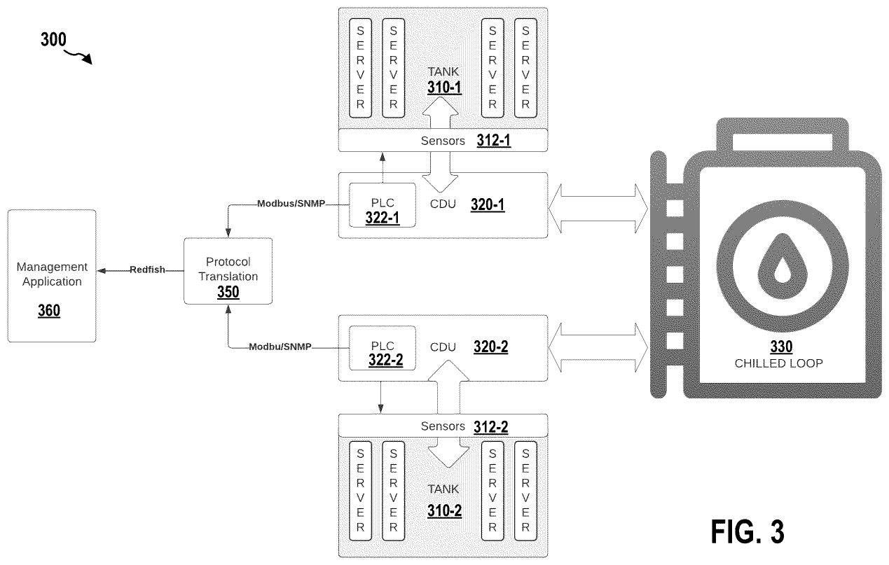

FIG. 3 is a diagram 300 illustrating a management architecture for a liquid cooling system in a data center environment. The architecture implements a hierarchical control and monitoring structure that spans from sensor-level components to high-level management applications. In this example, there are two parallel cooling subsystems connected to a common chilled loop 330, with each subsystem comprising sensors, tanks, and control units.

In the first subsystem, a tank 310-1 contains an array of servers submerged in dielectric liquid. The tank 310-1 is monitored by sensors 312-1, which include multiple server monitoring elements arranged in a grid pattern. A CDU 320-1 manages the cooling operations for this subsystem, with an integrated programmable logic controller (PLC) 322-1 that processes sensor data and controls cooling parameters. The PLC 322-1 communicates with the sensors 312-1 to maintain optimal cooling conditions within the tank 310-1.

The second subsystem mirrors this configuration, with a tank 310-2 monitored by sensors 312-2 and managed by a CDU 320-2 containing a PLC 322-2. This parallel arrangement demonstrates how the architecture can scale to support multiple cooling zones within a data center. Both CDU 320-1 and CDU 320-2 connect to the chilled loop 330, which serves as the central heat dissipation mechanism for the entire system.

Different CDU vendors implement various communication protocols, including Modbus, SNMP, REST API, Redfish, and IoT MQTT. A protocol translation component 350 serves as an intermediary layer that converts these diverse protocols into a unified Redfish protocol for communication with a management application 360. The protocol translation component 350 addresses the challenge of protocol heterogeneity in data center cooling systems, where different vendors may implement various communication protocols.

The protocol translation component 350 can operate on various hardware platforms. It may run on an x86 server, an ARM-based server, or a small computing device such as a Raspberry Pi, depending on the scale of the deployment. This flexibility in deployment options allows data centers to select appropriate hardware based on their specific requirements and scale of operations.

The management application 360 represents a high level of control in the architecture. It communicates with the protocol translation component 350 via Redfish protocol to obtain a comprehensive view of the cooling infrastructure's status. The management application 360 processes information from both cooling subsystems, enabling administrators to monitor and manage the entire cooling infrastructure through a unified interface.

Further, redundancy can be implemented at multiple levels. Each tank is equipped with multiple sensors for reliable monitoring, and the parallel arrangement of cooling subsystems provides system-level redundancy. This design allows for continued operation even if one subsystem experiences issues, as the management application 360 can detect failures and initiate appropriate responses based on the predefined failure management protocols.

The management application 360 can pull information from each CDU to monitor their behavior and continuously verify proper operation of all components. This comprehensive monitoring and control capability is particularly important in modern data centers where high-power computing components generate substantial heat loads that must be managed efficiently and reliably. The management application 360 can also operate in a simulation mode, creating a digital twin of the cooling infrastructure to test various failure scenarios and response strategies without affecting the actual data center operations.

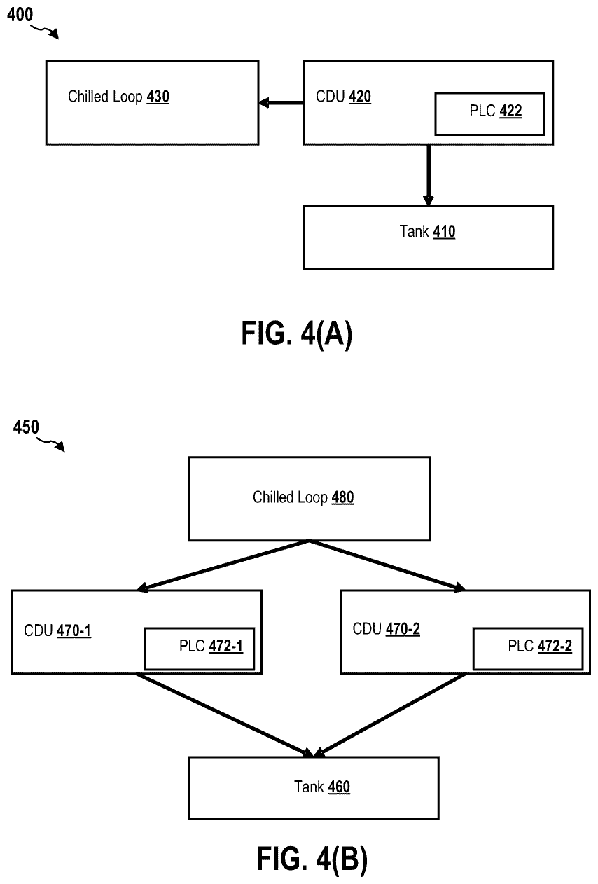

FIGS. 4(A) and 4(B) are diagrams 400 and 450 illustrating different cooling topology configurations for data center environments. These configurations demonstrate how cooling components can be arranged to provide various levels of redundancy and reliability.

More specifically, FIG. 4(A) shows a basic 1×1 configuration with no redundancy. The configuration includes a tank 410 that receives cooling from a single CDU 420. The CDU 420 contains an integrated PLC 422 for control and monitoring functions. A chilled loop 430 connects to the CDU 420 to provide the primary cooling medium. This represents the simplest topology where a single CDU manages a single tank, offering no component redundancy.

FIG. 4(B) illustrates a more complex configuration that implements redundancy at the CDU level. In this arrangement, two CDUs (the CDU 470-1 and the CDU 470-2) are connected to a single tank 460. Each CDU contains its own PLC (the PLC 472-1 and the PLC 472-2 respectively) for independent control capabilities. Both CDUs connect to a common chilled loop 480. This configuration can operate in multiple modes-either with one CDU active and another passive for failover scenarios, or with both CDUs operating simultaneously in an active-active arrangement.

The liquid cooling infrastructure supports several advanced redundancy configurations beyond the basic single CDU-to-tank and dual CDU arrangements shown in FIG. 4(A) and FIG. 4(B). A single CDU can be configured to manage multiple tanks in what is termed a multiple redundancy matrix configuration. In this arrangement, a CDU, such as the CDU 320-1, can distribute cooling capacity across multiple immersion tanks while maintaining independent sensor monitoring through the PLC 322-1 for each connected tank.

The N+N redundancy setup extends the dual CDU configuration shown in FIG. 4(B) to accommodate larger scale deployments. This configuration implements a matched set of active and backup CDUs, where N represents the number of primary CDUs required for normal operation, with an equal number of backup CDUs available for failover scenarios. For example, in a three-plus-three redundancy implementation, three primary CDUs operate in active mode while three backup CDUs remain in standby, ready to take over cooling functions if any primary unit experiences a failure.

The partial redundancy configuration offers a middle ground between full N+N redundancy and non-redundant setups. In this arrangement, critical components within the CDUs receive redundant backup while non-critical elements maintain single-unit operation. A CDU implementing partial redundancy might include redundant pumps and power supplies while maintaining single cooling loops or control systems.

These redundancy configurations can be defined and managed through the protocol translation component 350 and the management application 360. The management application 360 receives status information from the PLCs within each CDU via the protocol translation component 350, which converts vendor-specific protocols to the Redfish protocol. This standardized communication enables the management application 360 to monitor and control the cooling infrastructure regardless of the specific redundancy configuration implemented.

The chilled loop, such as the chilled loop 330, maintains its role as the central cooling medium across all redundancy configurations. The management application 360 coordinates the operation of multiple CDUs and their associated PLCs to maintain optimal cooling performance while adhering to the redundancy requirements specified in the system configuration.

The management application 360 utilizes a data structure, such as a JSON-formatted document, to define a planning template for a liquid cooling infrastructure in a data center. This planning template describes the complete topology of the cooling system, including the chillers, the chiller loops, the CDUs, and the immersion tanks.

An exemplary schema of the data structure is as follows:

```
{
  “$schema”: “http://json-schema.org/draft-07/schema#”,
  “type”: “object”,
  “properties”: {
    “cooling_infrastructure”: {
      “type”: “object”,
      “properties”: {
        “chiller”: {
          “type”: “object”,
          “properties”: {
            “type”: {
              “type”: “string”
            },
            “cooling_capacity”: {
              “type”: “string”
            },
            “redundancy”: {
              “type”: “string”
            },
            “fmea”: {
              “type”: “object”,
              “properties”: {
                “failure_modes”: {
                  “type”: “array”,
                  “items”: {
                    “type”: “object”,
                    “properties”: {
                      “mode”: {
                        “type”: “string”
                      },
                      “effects”: {
                        “type”: “string”
                      },
                      “causes”: {
                        “type”: “string”
                      },
                      “detection_methods”: {
                        “type”: “string”
                      },
                      “recommended_actions”: {
                        “type”: “string”
                      }
                    },
                    “required”: [
                    “mode”,
                    “effects”,
                    “causes”,
                    “detection_methods”,
                    “recommended_actions”
                    ]
                  }
                }
              },
              “required”: [
              “failure_modes”
              ]
            }
          },
          “required”: [
          “type”,
          “cooling_capacity”,
          “redundancy”,
          “fmea”
          ]
        },
        “chiller_loop”: {
          “type”: “object”,
          “properties”: {
            “coolant_type”: {
              “type”: “string”
            },
            “flow_rate”: {
              “type”: “string”
            },
            “temperature_range”: {
              “type”: “object”,
              “properties”: {
                “min”: {
                  “type”: “string”
                },
                “max”: {
                  “type”: “string”
                }
              },
              “required”: [
              “min”,
              “max”
              ]
            },
            “fmea”: {
              “type”: “object”,
              “properties”: {
                “failure_modes”: {
                  “type”: “array”,
                  “items”: {
                    “type”: “object”,
                    “properties”: {
                      “mode”: {
                        “type”: “string”
                      },
                      “effects”: {
                        “type”: “string”
                      },
                      “causes”: {
                        “type”: “string”
                      },
                      “detection_methods”: {
                        “type”: “string”
                      },
                      “recommended_actions”: {
                        “type”: “string”
                      }
                    },
                    “required”: [
                    “mode”,
                    “effects”,
                    “causes”,
                    “detection_methods”,
                    “recommended_actions”
                    ]
                  }
                }
              },
              “required”: [
              “failure_modes”
              ]
            }
          },
          “required”: [
          “coolant_type”,
          “flow_rate”,
          “temperature_range”,
          “fmea”
          ]
        },
        “cdus”: {
          “type”: “array”,
          “items”: {
            “type”: “object”,
            “properties”: {
              “id”: {
                “type”: “string”
              },
              “Protocol”: {
                “type”: “string”
              },
              “associated_tanks”: {
                “type”: “array”,
                “items”: {
                  “type”: “object”,
                  “properties”: {
                    “tank_id”: {
                      “type”: “string”
                    }
                  },
                  “required”: [
                  “tank_id”
                  ]
                }
              },
              “redundancy”: {
                “type”: “string”
              },
              “fmea”: {
                “type”: “object”,
                “properties”: {
                  “failure_modes”: {
                    “type”: “array”,
                    “items”: {
                      “type”: “object”,
                      “properties”: {
                        “mode”: {
                          “type”: “string”
                        },
                        “effects”: {
                          “type”: “string”
                        },
                        “causes”: {
                          “type”: “string”
                        },
                        “detection_methods”: {
                          “type”: “string”
                        },
                        “recommended_actions”: {
                          “type”: “string”
                        }
                      },
                      “required”: [
                      “mode”,
                      “effects”,
                      “causes”,
                      “detection_methods”,
                      “recommended_actions”
                      ]
                    }
                  }
                },
                “required”: [
                “failure_modes”
                ]
              }
            },
            “required”: [
            “id”,
            “Protocol”,
            “associated_tanks”,
            “redundancy”,
            “fmea”
            ]
          }
        },
        “immersion_tanks”: {
          “type”: “array”,
          “items”: {
            “type”: “object”,
            “properties”: {
              “id”: {
                “type”: “string”
              },
              “dimensions”: {
                “type”: “object”,
                “properties”: {
                  “length”: {
                    “type”: “string”
                  },
                  “width”: {
                    “type”: “string”
                  },
                  “height”: {
                    “type”: “string”
                  }
                },
                “required”: [
                “length”,
                “width”,
                “height”
                ]
              },
              “cooling_type”: {
                “type”: “string”
              },
              “max_wattage”: {
                “type”: “string”
              },
              “redundancy”: {
                “type”: “string”
              },
              “fmea”: {
                “type”: “object”,
                “properties”: {
                  “failure_modes”: {
                    “type”: “array”,
                    “items”: {
                      “type”: “object”,
                      “properties”: {
                        “mode”: {
                          “type”: “string”
                        },
                        “effects”: {
                          “type”: “string”
                        },
                        “causes”: {
                          “type”: “string”
                        },
                        “detection_methods”: {
                          “type”: “string”
                        },
                        “recommended_actions”: {
                          “type”: “string”
                        }
                      },
                      “required”: [
                      “mode”,
                      “effects”,
                      “causes”,
                      “detection_methods”,
                      “recommended_actions”
                      ]
                    }
                  }
                },
                “required”: [
                “failure_modes”
                ]
              }
            },
            “required”: [
            “id”,
            “dimensions”,
            “cooling_type”,
            “max_wattage”,
            “redundancy”,
            “fmea”
            ]
          }
        },
        “failure_management”: {
          “type”: “object”,
          “properties”: {
            “monitoring”: {
              “type”: “object”,
              “properties”: {
                “parameters”: {
                  “type”: “array”,
                  “items”: {
                    “type”: “string”
                  }
                },
                “frequency”: {
                  “type”: “string”
                },
                “thresholds”: {
                  “type”: “object”
                }
              },
              “required”: [
              “parameters”,
              “frequency”,
              “thresholds”
              ]
            },
            “alerts”: {
              “type”: “object”,
              “properties”: {
                “methods”: {
                  “type”: “array”,
                  “items”: {
                    “type”: “string”
                  }
                },
                “recipients”: {
                  “type”: “array”,
                  “items”: {
                    “type”: “string”
                  }
                }
              },
              “required”: [
              “methods”,
              “recipients”
              ]
            },
            “automated_actions”: {
              “type”: “array”,
              “items”: {
                “type”: “object”,
                “properties”: {
                  “trigger”: {
                    “type”: “string”
                  },
                  “action”: {
                    “type”: “string”
                  }
                },
                “required”: [
                “trigger”,
                “action”
                ]
              }
            }
          },
          “required”: [
          “monitoring”,
          “alerts”,
          “automated_actions”
          ]
        }
      },
      “required”: [
      “chiller”,
      “chiller_loop”,
      “cdus”,
      “immersion_tanks”,
      “failure_management”
      ]
    }
  },
  “required”: [
  “cooling_infrastructure”
  ]
}
```

The schema follows a hierarchical structure where each component type contains specific properties and a failure modes and effects analysis (FMEA) section. The planning template serves as a comprehensive configuration and failure management guide for the management application 360. The planning template is ingested by the management application 360, providing prior knowledge of the system's topology, components, and potential failure modes.

More specifically, the data structure 500 conforms to a predefined schema (such as the exemplary schema infra), indicated by the “$schema” field, which specifies a JSON schema version (e.g., draft-07). The root of the data structure 500 is an object containing a single required property: “cooling_infrastructure”. The “cooling_infrastructure” property is itself an object with several required properties that represent the key components of the liquid cooling system.

The “chiller” property describes the chiller unit, such as the evaporative cooling tower or the dry cooler of the chilled loop 230, including its “type,” “cooling_capacity,” and “redundancy” configuration. A “fmea” (Failure Mode and Effects Analysis) section within the “chiller” property details potential “failure_modes.” Each failure mode includes a “mode” (description of the failure), “effects” (consequences of the failure), “causes” (potential origins of the failure), “detection_methods” (how the failure is detected, e.g., via sensors 312-1, sensors 312-2, or other sensors), and “recommended_actions” (steps to mitigate or resolve the failure).

The “chiller_loop” property describes the chilled water loop, such as the chilled loop 230, chilled loop 330, chilled loop 430, or chilled loop 480, including its “coolant_type,” “flow_rate,” and “temperature_range” (with “min” and “max” values). Similar to the “chiller” property, it also includes a “fmea” section with detailed “failure_modes” specific to the chiller loop.

The “cdus” property is an array of objects, each representing a cooling distribution unit (CDU), such as the CDU 220, CDU 320-1, CDU 320-2, CDU 420, CDU 470-1, or CDU 470-2. Each CDU object includes an “id,” the “Protocol” used for communication (e.g., Modbus, SNMP, or Redfish, which may require a protocol translation component 350), an “associated_tanks” array (listing the “tank_id” of each associated immersion tank, such as the tank 210, tank 310-1, tank 310-2, tank 410, or tank 460), a “redundancy” specification, and a “fmea” section. The “fmea” section describes the failure mode of the CDU, including its redundant pumps, redundant power supplies, or other redundant components.

The “immersion_tanks” property is an array of objects, each representing a liquid immersion tank, such as the liquid immersion tank 210, tank 310-1, tank 310-2, tank 410, or tank 460. Each tank object includes an “id,” “dimensions” (length, width, height), “cooling_type,” “max_wattage,” “redundancy” details, and a “fmea” section. The redundancy may be supported by multiple CDUs, such as the configuration shown in FIG. 4(B).

The “failure_management” property defines system-wide failure handling procedures. It includes a “monitoring” section specifying “parameters” to be monitored (e.g., temperature, pressure, flow rate, etc., measured by sensors such as sensors 312-1 and 312-2), “frequency” of monitoring, and “thresholds” for triggering alerts. An “alerts” section describes “methods” of alert notification (e.g., email, SMS) and “recipients” of the alerts. Finally, an “automated_actions” section defines actions to be automatically executed based on specific “trigger” conditions. These automated actions might include activating a backup pump, adjusting flow rates, or shutting down a component. The planning template therefore allows for proactive responses to be configured based on predefined failure scenarios.

The data center administrator, or a data center planner, creates an instance of this data structure 500, providing values specific to their data center's configuration. This completed planning template is then provided to the management application 360. The management application 360 parses this planning template, and based on the described topologies, components, failure modes, and actions, establishes the appropriate monitoring, alerting, and control procedures for the liquid cooling system. This helps the management application 360 take programmatic actions, show manual actions, and gather information to display to an administrator in a real deployment or simulated environment to test out various scenarios. The simulation capability allows administrators to validate their configuration and response strategies before implementing them in the production environment.

Understanding the relationship between the CDU and its subcomponents contributes to effective data center management. The CDU 320-1 communicates with the PLC 322-1, which collects sensor data and controls pumps or valves to maintain stable operating conditions in the tank 310-1. Sensor assemblies, such as the sensors 312-1, capture temperature and pressure readings and report them to the PLC. The PLC then interprets this information to adjust pump speeds and flow rates. A second subsystem, reflected in the tank 310-2 and sensors 312-2 arrangement, operates in parallel with its own CDU 320-2 and PLC 322-2, all connecting to the common chilled loop 330. A higher-level management application 360 communicates via a protocol translation component 350, which handles the conversion between Modbus, SNMP, and Redfish protocols. This approach makes it possible for the management application 360 to coordinate multiple subsystems, gather sensor readings, and activate measures when anomalies arise.

When deploying a large number of CDUs, each containing one or more redundant pumps, power supplies, or controllers, failures in any individual module can introduce significant risks. In light of the configurations described in the discussion of pump failures or coolant leaks, a failure modes and effects analysis (FMEA) conveys a structured methodology for identifying possible events such as a pump that refuses to start or a sensor that drifts from calibration. The resulting impact might include rising immersion temperatures. The recommended actions may prescribe initiating predictive maintenance or switching to an alternative cooling path to preserve stable operations. Additional response strategies include remote monitoring of power supplies, routine firmware updates for primary control systems, and sensor calibration. These measures can reduce the frequency of system downtime and mitigate the consequences of mechanical or electrical faults.

A planning template specifies how the overall infrastructure is assembled. Each chiller or chilled loop describes its cooling capacity, redundancy characteristics, and failure modes. Every CDU, for instance the CDU 320-1 or the CDU 470-1, references the tanks it serves and annotates potential issues that might arise. Each immersion tank, like the tank 460, similarly defines power consumption and layout details, with redundancy entries reflecting whether more than one CDU is present. The JSON-based planning template records these relationships in a structured way, describing the coolant type and flow rates, alert thresholds, and recommended mitigation approaches. Administrators fill out the template to match the specific data center environment, after which the management application 360 ingests the plan and configures automated actions or alerts in a real deployment or simulated environment to test out various scenarios. This simulation capability, functioning as a digital twin of the physical infrastructure, allows administrators to validate their configuration and response strategies in a safe environment before implementing them in the actual data center.

Through this combination of redundant hardware design, sensor monitoring, and a structured planning template, data center operators are able to handle component failures while preserving acceptable operational temperatures for the submerged electronics. A typical failure involves a coolant leak in the CDU's loop piping. In such an event, sensors detect pressure variations and changes in fluid levels. The management application 360 consults the failure actions defined in the JSON plan to notify relevant operators and suspend non-critical workloads. If the system design includes parallel CDUs, or partial redundancy that covers pumps or coolants, the management application 360 can shift demand to a standby loop while repairs or inspections are conducted. This process makes it possible to maintain a predictable thermal environment, even in the face of hardware anomalies, software bugs in the PLC, or sensor inaccuracies. These failure scenarios can be simulated in a digital twin environment, allowing administrators to test and refine their response strategies without risking the operational integrity of the actual data center.

When these measures are aggregated, the result is a robust cooling ecosystem that is tracked and orchestrated from a unified control plane. The management application 360, coordinating with each PLC through the protocol translation component 350, implements a mixture of automatic and manual actions for a variety of failure modes ranging from a single pump malfunction to catastrophic chiller faults. Each event sequence is defined by the planning document's set of possible failures, system responses, and recommended operator interventions. The arrangement reduces unexpected downtime and supports continuous monitoring for anomalies such as leaks or overheating within the immersion tanks. This adaptive framework, supported by distributed sensing and control, meets the needs of modern high-density computing environments, where submersion cooling and continuous operation are both priorities.

The planning template provides a structured approach for implementing failure mode and effects analysis (FMEA) for the liquid cooling infrastructure components. For each component in the system, the template captures detailed information about potential failure modes, their effects, causes, detection methods, and recommended actions in a real deployment or simulated environment to test out various scenarios. The simulation capability allows administrators to validate their FMEA strategies and response procedures in a digital twin environment before implementing them in the production data center, reducing the risk of unexpected outcomes during actual failure events.

The redundant pumps within the CDU 220 represent a critical component for maintaining coolant circulation. When one pump fails to start, the system experiences reduced coolant flow and increased coolant temperature. Such failures typically stem from mechanical wear or electrical faults. The current implementation utilizes redundant pump design and regular maintenance as control measures. The risk assessment assigns values of severity (3), occurrence (2), and detection (4). To address these risks, the management application 360 implements predictive maintenance protocols based on pump runtime data collected through the PLC 322-1 or PLC 322-2.

The redundant power supplies in the CDU 220 are designed to maintain continuous operation of the cooling system. A power supply failure can result in the loss of power to one pump, leading to reduced coolant flow. These failures commonly originate from electrical faults or overheating conditions. The system employs redundant power supply design and over-temperature protection mechanisms. The risk assessment indicates severity (3), occurrence (2), and detection (3) values. The management application 360 implements remote monitoring of power supply status through the protocol translation component 350.

The redundant control systems, including the PLC 322-1 and PLC 322-2, manage the operational parameters of the cooling infrastructure. A primary control system failure can result in loss of control over pumps and sensors, potentially leading to overheating conditions. These failures may arise from software bugs or hardware faults. The current implementation includes redundant control system design with failover mechanisms. The risk assessment shows severity (4), occurrence (1), and detection (3). The management application 360 coordinates regular software updates and hardware inspections through the protocol translation component 350.

Temperature and pressure sensors, such as the sensors 312-1 and sensors 312-2, provide critical monitoring capabilities. When these sensors provide inaccurate readings, the system may experience incorrect temperature or pressure data leading to inefficient cooling. Sensor drift and mechanical damage are common causes of these failures. The implementation uses redundant sensor design and regular calibration procedures. The risk assessment indicates severity (2), occurrence (3), and detection (2). The management application 360 implements sensor data analytics to detect anomalies through the protocol translation component 350 in a real deployment or simulated environment to test out various scenarios. The simulation environment allows administrators to inject artificial sensor anomalies and validate the system's detection and response mechanisms without affecting the actual cooling infrastructure.

The coolant loops connecting the CDU 220 to the chilled loop 230 are susceptible to coolant leaks. Such leaks result in coolant loss and reduced cooling efficiency. These failures typically stem from mechanical damage or material defects. The current implementation employs redundant coolant loop design and leak detection sensors. The risk assessment shows severity (4), occurrence (1), and detection (3). The management application 360 coordinates regular inspections and leak testing procedures through the protocol translation component 350.

The planning template structures this information in a JSON format that can be consumed by the management application 360. When the template is imported, the management application 360 establishes monitoring parameters, alert thresholds, and automated response actions based on the specified failure modes and their characteristics. This systematic approach enables proactive management of potential failures in the liquid cooling infrastructure while maintaining optimal cooling performance for the immersed servers in the tank 210.

More specifically, in this example, the management application 360, as described in FIG. 3, utilizes a planning template to proactively manage potential failures within the liquid cooling infrastructure. This planning template, structured as a JSON document, incorporates a FMEA entry for each critical component. The FMEA entry identifies potential failure modes, their effects, causes, detection methods, and recommended actions. This information is then used by the management application 360 to configure monitoring, alerting, and automated responses.

The FMEA entries within the planning template are organized hierarchically. For example, within the “cdus” section, each CDU object (such as the CDU 220, CDU 320-1, or CDU 470-1) contains an “fmea” field. This field holds an array of “failure_modes”. Each element in this array represents a specific failure scenario for that CDU. A failure mode object includes the following fields: “mode” (a description of the failure), “effects” (the consequences of the failure), “causes” (potential reasons for the failure), “detection_methods” (how the failure is identified), and “recommended_actions” (steps to mitigate or resolve the failure).

For instance, consider the redundant pumps within a CDU. A potential failure mode is “One pump fails to start”. The “effects” of this failure would be “Reduced coolant flow, increased coolant temperature”. The “causes” might include “Mechanical wear, electrical fault”. The “detection_methods” could involve “PLC sensor readings” from the PLC 322-1 or PLC 472-1, monitoring pump speed and flow rate. The “recommended_actions” would be “Implement predictive maintenance based on pump runtime; Activate standby pump”. This detailed information allows the management application 360 to automatically switch to a redundant pump if one fails, based on pre-configured triggers and actions defined in the planning template.

Similarly, for redundant power supplies, a failure mode might be “One power supply fails,” with “effects” such as “Loss of power to one pump, reduced coolant flow.” “Causes” could include “Electrical fault, overheating,” and “detection_methods” could involve “PLC sensor readings” monitoring voltage and current. “Recommended_actions” might be to “Implement remote monitoring of power supply status; Switch to redundant power supply”. The management application 360, upon detecting a power supply failure via the protocol translation component 350, can automatically initiate a switchover.

Redundant control systems are also addressed in the FMEA. A “Primary control system fails” mode could have “effects” like “Loss of control over pumps and sensors, potential overheating.” “Causes” could include a “Software bug, hardware fault”. “Detection_methods” could involve a “Watchdog timer, heartbeat signal”. “Recommended actions” are “Regular software updates and hardware inspections, Failover to secondary control system”. The management application 360 would trigger a failover to the backup control system upon detecting a failure in the primary system.

For temperature and pressure sensors, such as sensors 312-1 or sensors 312-2, a failure mode could be “Sensor provides inaccurate readings,” leading to “effects” of “Incorrect temperature or pressure data, inefficient cooling.” “Causes” might include “Sensor drift, mechanical damage”. “Detection_methods” could involve “Comparison with redundant sensors, outlier detection.” “Recommended_actions” would include “Implement sensor data analytics to detect anomalies; Recalibrate or replace sensor.” The management application 360 uses this information to identify and flag potentially faulty sensors.

Finally, coolant loops, such as the chilled loop 230, chilled loop 330, chilled loop 430, or chilled loop 480, are analyzed. A “Coolant leak” failure mode would have “effects” of “Loss of coolant, reduced cooling efficiency.” “Causes” would be “Mechanical damage, material defects.” “Detection_methods” could involve “Flow rate sensors, pressure sensors, liquid level sensors.” “Recommended_actions” consist of “Implement regular inspections and leak testing; Isolate affected loop, initiate repair.” The management application 360, upon detecting a leak, can alert administrators and potentially isolate the affected loop if the system design allows.

The planning template is ingested by the management application 360. The management application 360 then sets up monitoring based on the “parameters,” “frequency,” and “thresholds” defined in the “failure_management” section of the planning template. Alerts are configured based on the “methods” and “recipients” specified. Automated actions, defined by “trigger” and “action” pairs, are also established. This allows the management application 360 to react dynamically to various failure scenarios, taking actions such as activating backup components, adjusting system parameters, or notifying personnel. The planning template approach allows the system to be pre-configured to handle various failure situations, minimizing downtime. The data center administrator provides the data to fill out the planning template. The management application receives this template.

As described supra, the management application 360 ingests a planning template, which is a data structure, such as a JSON-formatted document, that defines the cooling infrastructure's topology, components, failure modes, and recommended actions. The planning template is created by a data center administrator or a data center planner based on the specific configuration of the liquid cooling system. This template acts as a “recipe file,” providing the management application 360 with prior knowledge of the system's setup. This enables the management application 360 to effectively monitor the system, detect anomalies, and take appropriate actions, whether automated or manual, in both real deployments and simulated environments. The simulation capability, functioning as a digital twin of the physical infrastructure, allows administrators to test various scenarios and validate their response strategies without risking the operational integrity of the actual data center.

The planning template includes detailed FMEA information for each component. The management application 360 uses this information to configure its monitoring and control procedures. For example, if a pump failure is detected via the PLC 322-1 or PLC 472-1 sensor readings, the management application 360 can automatically activate a standby pump, as defined in the planning template's automated actions.

The management application 360, after importing the planning template, understands the overall setup of the data center's liquid cooling infrastructure. This includes the relationships between the components, such as which CDUs (e.g., the CDU 320-1 or the CDU 470-1) are associated with which immersion tanks (e.g., the tank 310-1 or the tank 460), and the redundancy configurations (e.g., 1×1, dual CDU, N+N, or partial redundancy). The planning template also specifies the communication protocols used by each component (e.g., Modbus, SNMP, Redfish), which informs the management application 360 how to interact with the various devices through the protocol translation component 350.

Based on the planning template, the management application 360 sets up monitoring groups and thresholds for various parameters, such as temperature, pressure, and flow rate, collected from sensors like the sensors 312-1 and sensors 312-2. It also configures alert notifications and automated actions based on the FMEA data. If an anomaly is detected, such as a coolant leak detected by sensors in a coolant loop, the management application 360 can consult the planning template to determine the appropriate response. This might involve alerting personnel, activating backup components, or adjusting system parameters. For manual actions, the management application displays recommended actions to administrators, providing guidance for resolving the issue.

The data center administrator or planner uses a user interface, possibly a wizard-like interface, to create the planning template. This interface allows them to select components (e.g., pumps, chillers, CDUs, tanks), define failure modes, specify effects and causes, and enter recommended actions. This input is then used to generate the JSON document that is ingested by the management application 360.

The planning template approach allows for a flexible and adaptable system. Different data centers can have various liquid cooling configurations and vendor-specific components, each having its own failure modes and management methods. The planning template supports a broad range of configurations and actions, including programmable actions taken by the management application 360 and manual actions that an administrator can initiate. The management application uses the planning template to set up monitoring parameters and alert thresholds in both real deployments and simulated environments. The simulation capability allows administrators to create a digital twin of their cooling infrastructure, where they can test various configurations, failure scenarios, and response strategies before implementing them in the production environment.

Further, the management application 360 exposes a set of APIs that can be integrated with the planning template. When defining actions in the template, administrators can specify which API calls should be triggered in response to specific error conditions. This programmatic approach is complemented by the ability to define manual actions for scenarios that require human intervention.

The separation of roles between the data center planner and administrator is reflected in the system's design. The planner, who understands the overall infrastructure setup, completes the planning template with detailed information about the cooling system's topology and failure management procedures. The administrator, responsible for ongoing monitoring and maintenance, uses this template through the management application 360 to respond to issues according to the predefined procedures.

When the management application 360 is deployed to a new data center, the planning template serves as a recipe file that defines how the specific infrastructure should be monitored and managed. The template is ingested by the management application 360, which then establishes the appropriate monitoring parameters, alert thresholds, and automated responses based on the template's specifications.

The system's architecture accommodates various redundancy configurations, from simple 1×1 setups to complex N+N arrangements. The planning template allows administrators to define these redundancy relationships and specify how the system should respond to component failures within each configuration. This flexibility enables the management application 360 to adapt to different data center designs while maintaining consistent management practices across diverse installations. Additionally, the management application 360 can operate in a simulation mode, creating a digital twin of the cooling infrastructure to test various redundancy configurations and failure scenarios without affecting the actual data center operations. This simulation capability allows administrators to validate their redundancy strategies and response procedures before implementing them in the production environment, reducing the risk of unexpected outcomes during actual failure events.

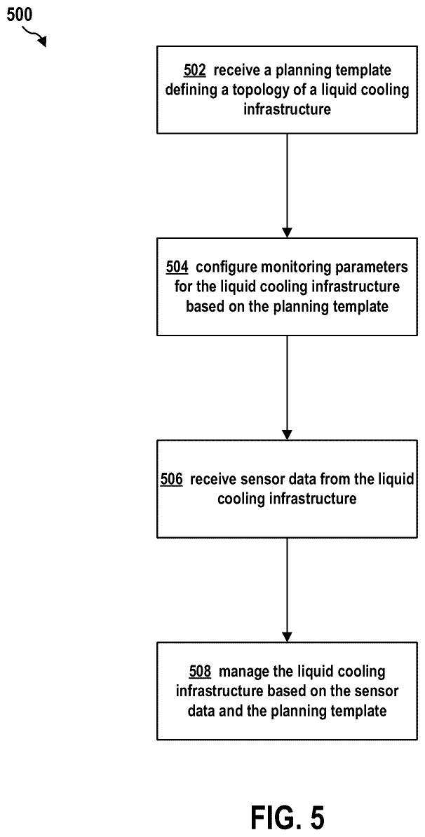

FIG. 5 is a flow chart 500 of a method for managing a liquid cooling infrastructure. The method may be performed by one or more computing devices (e.g., the management application 360). In operation 502, the one or more computing devices receive a planning template defining a topology of a liquid cooling infrastructure, the planning template comprising one or more component entries for one or more components of the liquid cooling infrastructure. In operation 504, the one or more computing devices configure monitoring parameters for the liquid cooling infrastructure based on the planning template. In operation 506, the one or more computing devices receive sensor data from the liquid cooling infrastructure. The liquid cooling infrastructure includes at least one of: a physical liquid cooling infrastructure or a simulated liquid cooling infrastructure. In operation 508, the one or more computing devices manage the liquid cooling infrastructure based on the sensor data and the planning template.

In certain configurations, the one or more component entries comprise a failure modes and effects analysis (FMEA) section. The FMEA section comprises one or more failure modes, and each of the one or more failure modes comprises a mode, effects, causes, detection methods, and recommended actions.

In certain configurations, the one or more components comprise at least one of: a chiller, a chiller loop, one or more cooling distribution units (CDUs), or one or more immersion tanks.

To manage the liquid cooling infrastructure, the one or more computing devices detect an anomaly based on the sensor data and the monitoring parameters, identify, from the planning template, one or more recommended actions corresponding to the detected anomaly, and execute at least one of the identified recommended actions.

In certain configurations, the planning template further defines monitoring parameters comprising sensor thresholds and monitoring frequency, alert methods and alert recipients, and automated actions comprising triggers and corresponding actions.

In certain configurations, the one or more computing devices receive protocol data from the one or more components using different communication protocols and translate the protocol data to a unified protocol format before managing the liquid cooling infrastructure. The different communication protocols comprise at least two of: Modbus, SNMP, REST API, Redfish, or IoT MQTT, and the unified protocol format is Redfish.

In certain configurations, the planning template defines redundancy configurations for the one or more components, the redundancy configurations comprising at least one of: a one-to-one configuration, a dual CDU configuration, an N+N redundancy configuration, or a partial redundancy configuration.

To manage the liquid cooling infrastructure, the one or more computing devices monitor operational parameters of redundant components, detect a failure in a primary component, and automatically switch operation to a corresponding redundant component based on redundancy information defined in the planning template.

In certain configurations, the one or more computing devices display, via a user interface, a planning template creation wizard, receive, via the user interface, component selections and failure management information, and generate the planning template based on the received component selections and failure management information.

In certain configurations, the sensor data comprise at least one of: temperature data, pressure data, flow rate data, liquid level data, or pump speed data.

To manage the liquid cooling infrastructure, the one or more computing devices identify automated actions and manual actions from the planning template, execute the automated actions programmatically, and display the manual actions via a user interface.

In certain configurations, the planning template defines associations between cooling distribution units (CDUs) and immersion tanks, and to manage the liquid cooling infrastructure, the one or more computing devices control the CDUs based on the defined associations.

To configure the monitoring parameters, the one or more computing devices extract threshold values and monitoring frequencies from the planning template, establish monitoring groups for different components based on the planning template, and configure alerts based on alert methods and alert recipients defined in the planning template.

To manage the liquid cooling infrastructure, the one or more computing devices detect a coolant leak based on the sensor data, identify, from the planning template, leak management procedures, and execute automated leak management actions while displaying manual leak management actions to an administrator.

In certain configurations, the simulated liquid cooling infrastructure includes a digital twin of the physical liquid cooling infrastructure. To manage the simulated liquid cooling infrastructure, the one or more computing devices simulate failure scenarios based on the planning template. The one or more computing devices validate response strategies for the simulated failure scenarios. The one or more computing devices implement validated response strategies in the physical liquid cooling infrastructure.

The management application and protocol translation component described in FIGS. 2-5 may be implemented by the host computer 180 shown in FIG. 1. Specifically, the host CPU 182 may execute instructions stored in the host memory 184 or storage device(s) 185 to implement the management application 360's functions of receiving and processing the planning template, configuring monitoring parameters, receiving sensor data through the protocol translation component 350, and managing the liquid cooling infrastructure based on the sensor data and planning template. The component devices 186-1 to 186-N may include network controllers that enable communication with the CDUs, PLCs, and sensors of the liquid cooling infrastructure through various protocols such as Modbus, SNMP, REST API, Redfish, or IoT MQTT. The host computer 180 may communicate with these cooling infrastructure components either through direct connections or through the communication network 170, while maintaining separation from the data network 172 used for regular data center operations.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving a planning template defining a topology of a liquid cooling infrastructure, the planning template comprising one or more component entries for one or more components of the liquid cooling infrastructure;
configuring monitoring parameters for the liquid cooling infrastructure based on the planning template;
receiving sensor data from the liquid cooling infrastructure, wherein the liquid cooling infrastructure comprises at least one of: a physical liquid cooling infrastructure or a simulated liquid cooling infrastructure; and
managing the liquid cooling infrastructure based on the sensor data and the planning template.

2. The method of claim 1, wherein the one or more component entries comprise:
a failure modes and effects analysis (FMEA) section, the FMEA section comprising one or more failure modes, and wherein each of the one or more failure modes comprises a mode, effects, causes, detection methods, and recommended actions.

3. The method of claim 1, wherein the one or more components comprise at least one of: a chiller, a chiller loop, one or more cooling distribution units (CDUs), or one or more immersion tanks.

4. The method of claim 1, wherein managing the liquid cooling infrastructure comprises:
detecting an anomaly based on the sensor data and the monitoring parameters;
identifying, from the planning template, one or more recommended actions corresponding to the detected anomaly; and
executing at least one of the identified recommended actions.

5. The method of claim 1, wherein the planning template further defines:
monitoring parameters comprising sensor thresholds and monitoring frequency;
alert methods and alert recipients; and
automated actions comprising triggers and corresponding actions.

6. The method of claim 1, further comprising:
receiving protocol data from the one or more components using different communication protocols; and
translating the protocol data to a unified protocol format before managing the liquid cooling infrastructure.

7. The method of claim 6, wherein:
the different communication protocols comprise at least two of: Modbus, SNMP, REST API, Redfish, or IoT MQTT; and
the unified protocol format is Redfish.

8. The method of claim 1, wherein the planning template defines redundancy configurations for the one or more components, the redundancy configurations comprising at least one of: a one-to-one configuration, a dual CDU configuration, an N+N redundancy configuration, or a partial redundancy configuration.

9. The method of claim 1, wherein managing the liquid cooling infrastructure comprises:
monitoring operational parameters of redundant components;
detecting a failure in a primary component; and
automatically switching operation to a corresponding redundant component based on redundancy information defined in the planning template.

10. The method of claim 1, further comprising:
displaying, via a user interface, a planning template creation wizard;
receiving, via the user interface, component selections and failure management information; and
generating the planning template based on the received component selections and failure management information.

11. The method of claim 1, wherein the sensor data comprise at least one of: temperature data, pressure data, flow rate data, liquid level data, or pump speed data.

12. The method of claim 1, wherein managing the liquid cooling infrastructure comprises:
identifying automated actions and manual actions from the planning template;
executing the automated actions programmatically; and
displaying the manual actions via a user interface.

13. The method of claim 1, wherein the planning template defines associations between cooling distribution units (CDUs) and immersion tanks, and wherein managing the liquid cooling infrastructure comprises controlling the CDUs based on the defined associations.

14. The method of claim 1, wherein configuring the monitoring parameters comprises:
extracting threshold values and monitoring frequencies from the planning template;
establishing monitoring groups for different components based on the planning template; and
configuring alerts based on alert methods and alert recipients defined in the planning template.

15. The method of claim 1, wherein managing the liquid cooling infrastructure comprises:
detecting a coolant leak based on the sensor data;
identifying, from the planning template, leak management procedures; and
executing automated leak management actions while displaying manual leak management actions to an administrator.

16. The method of claim 1, wherein the simulated liquid cooling infrastructure comprises a digital twin of the physical liquid cooling infrastructure, and wherein managing the simulated liquid cooling infrastructure comprises:
simulating failure scenarios based on the planning template;
validating response strategies for the simulated failure scenarios; and
implementing validated response strategies in the physical liquid cooling infrastructure.

17. A system, including one or more computing devices, comprising:
a memory; and
at least one processor coupled to the memory and configured to:
receive a planning template defining a topology of a liquid cooling infrastructure, the planning template comprising one or more component entries for one or more components of the liquid cooling infrastructure;
configure monitoring parameters for the liquid cooling infrastructure based on the planning template;
receive sensor data from the liquid cooling infrastructure, wherein the liquid cooling infrastructure comprises at least one of: a physical liquid cooling infrastructure or a simulated liquid cooling infrastructure; and
manage the liquid cooling infrastructure based on the sensor data and the planning template.

18. The system of claim 17, wherein the one or more component entries comprise:
a failure modes and effects analysis (FMEA) section, the FMEA section comprising one or more failure modes, and wherein each of the one or more failure modes comprises a mode, effects, causes, detection methods, and recommended actions.

19. The system of claim 17, wherein to manage the liquid cooling infrastructure, the at least one processor is configured to:
detect an anomaly based on the sensor data and the monitoring parameters;
identify, from the planning template, one or more recommended actions corresponding to the detected anomaly; and
execute at least one of the identified recommended actions.

20. A non-transitory computer-readable medium storing computer executable code for operating one or more computing devices, comprising code to:
receive a planning template defining a topology of a liquid cooling infrastructure, the planning template comprising one or more component entries for one or more components of the liquid cooling infrastructure;
configure monitoring parameters for the liquid cooling infrastructure based on the planning template;
receive sensor data from the liquid cooling infrastructure, wherein the liquid cooling infrastructure comprises at least one of: a physical liquid cooling infrastructure or a simulated liquid cooling infrastructure; and
manage the liquid cooling infrastructure based on the sensor data and the planning template.
